(19) United States
(12) Patent Application Publication
(10) Pub. No.: US 2016/0115300 A1
(43) Pub. Date: Apr. 28, 2016

(54) THERMOPLASTIC COMPOSITE MATERIAL COMPRISING A REINFORCING COMPONENT AND A POLY(PHENYLENE) POLYMER AND PROCESS TO MAKE SAID THERMOPLASTIC COMPOSITE MATERIAL

(71) Applicant: AONIX ADVANCED MATERIALS CORP., Ottawa (CA)

(72) Inventors: Jerome LE CORVEC, Ottawa (CA); Pierre COAT, Ottawa (CA); David LIEVIN, Gatineau (CA)

(73) Assignee: AONIX ADVANCED MATERIALS CORP., Ottawa (CA)

(21) Appl. No.: 14/775,481

(22) PCT Filed: Mar. 11, 2014
(86) PCT No.: PCT/CA2014/050207

§ 371 Date: Oct. 16, 2015

Related U.S. Application Data
(60) Provisional application No. 61/776,754, filed on Mar. 11, 2013.

(51) Int. Cl. C08K 7/06

(52) U.S. Cl. CPC C08K 7/06

(57) ABSTRACT

The present disclosure provides a composite material that includes a thermoplastic poly(phenylene) polymer and a re-enforcement component. The poly(phenylene) polymer includes para-phenylene units. At least a portion of the para-phenylene units may be substituted with a polar non-acid functional group. The thermoplastic poly(phenylene) polymer may also include meta-phenylene units. The disclosure also describes a method of making a composite material using a solvent-dissolved poly(phenylene) polymer and a reinforcing fiber.

### CROSS REFERENCE

This application claims the benefit of priority of U.S. Provisional Patent Application No. 61/776,754 filed Mar. 11, 2013, which is hereby incorporated by reference.

### FIELD

The present disclosure relates generally to composite materials. More particularly, the present disclosure relates to thermoplastic composite materials.

### BACKGROUND

Composites are materials formed from a mixture of two or more components that produce a material with properties or characteristics that are different from those of the individual materials. Most composites comprise two parts, namely a matrix component and a reinforcement component. Matrix components are the materials that bind the composite together and they are often less stiff than the reinforcement components. Composite materials may be shaped under pressure at elevated temperatures.

The matrix components encapsulate the reinforcement components in place and distribute the load among the reinforcement components. Since reinforcement components are often stiffer than the matrix material, they are the primary load-carrying components within the composite. Reinforcement components may come in many different forms, such as: fibers, fabrics, particles, or rods.

Structures based on composite materials comprising a polymer matrix containing fibrous material have been developed. Such structures have been used in high performance composite manufacturing and may exhibit high strength, damage tolerance, interlaminar fracture toughness, flexibility, or any combination thereof. In highly demanding applications, such as, for example, structural parts in automotive and aerospace applications, composite materials are desired due to a combination of lightweight, high strength and temperature resistance. Manufacturing techniques have been developed for impregnating the fibrous material with a polymer matrix to change the properties of the composite structure.

There are many different types of composites, including plastic composites. Each plastic resin has its own unique properties, which when combined with different reinforcements create composites with different mechanical and physical properties. Plastic composites are classified within two primary categories: thermoset and thermoplastic composites.

In the case of thermoset composites, after application of heat and pressure, thermoset resins undergo a chemical change that cross-links the molecular structure of the material. Once cured, a thermoset part cannot be remolded. Thermoset plastics resist higher temperatures and provide greater dimensional stability than most thermoplastics because of the tightly cross-linked structure found in thermosets.

In the case of thermoplastic composites, the matrix components are not crosslinked and, therefore, are not as constrained as thermoset materials and can be recycled and reshaped to create a new part.

Thermoplastics that are reinforced with high-strength, high-modulus fibers to form thermoplastic composites provide dramatic increases in strength and stiffness, as well as toughness and dimensional stability. Thermoplastic composites can be melted by heating, reshaped and reformed if necessary, and then solidified by cooling. Thermoplastic materials can be either amorphous or semi-crystalline, each with its own set of properties. Common matrix components for thermoplastic composites include polypropylene (PP), polyethylene (PE), polyetheretherketone (PEEK) and nylon.

The structure and properties of the fiber-matrix interface play a major role in determining the mechanical and physical properties of a composite material. Stresses acting on the matrix are transmitted to the fiber across the interface, so the fiber and matrix need to interact to use the full properties of the fiber. The strength of this interaction can determine the properties of the composite itself. A weak interaction produces a tough composite since energy can be absorbed by various mechanisms, such as fiber pullout. A strong interaction between the fibers and matrix can produce a brittle composite.

It is, therefore, desirable to provide a composite material with desirable physical properties.

### SUMMARY

Rigid-rod polymers include thermoplastic materials with desirable mechanical properties. The backbone structure of rigid-rod polymers is comprised primarily of directly linked phenylene units. This wholly aryl-aryl bonded backbone chemical structure confers desirable physical and mechanical attributes to these polymers, such as tensile strength and Young's modulus values that are higher than those of polypropylene (PP), polyethylene (PE), polyetheretherketone (PEEK) or nylon thermoplastics.

Previous attempts to create a composite from a rigid-rod thermoplastic matrix and reinforcing fibers include methods where the polymer is melted and the melted polymer is impregnated into the fibers, and methods where particles of polymer are used to impregnate the fibers.

Such methods have failed due to the lack of adhesion of the matrix to the fiber and poor control over the matrix/fiber distribution. Furthermore, the high melt viscosity exhibited by many rigid-rod polymers results in insufficient impregnation of the fiberous reinforcement component during the fiber impregnation phase of the composite manufacturing, during ply consolidation, or both.

The insufficient impregnation of the reinforcement component, in turn, may result in: (i) reduced adhesion between the reinforcement component and matrix, (ii) formation of voids in the matrix and associated undesirable physical properties of the composite; or (iii) both.

It is an object of the present disclosure to obviate or mitigate at least one disadvantage of previous composite materials.

In one aspect, the present disclosure provides a composite material that includes: a reinforcement component; and a thermoplastic poly(phenylene) polymer that includes para-phenylene units.

At least a portion of the para-phenylene units may be substituted with a polar non-acid functional group.

The thermoplastic poly(phenylene) polymer may also include meta-phenylene units. The para-phenylene and meta-phenylene units may be present in a ratio of from 500:1 to 1:4 mol/mol. In particular examples, the composite material para-phenylene and meta-phenylene units are present in a ratio of about 5:1 mol/mol.

The thermoplastic poly(phenylene) polymer may have a tensile modulus of about 5.5 to about 8 GPa. The thermoplastic poly(phenylene) polymer may have a tensile strength of about 150 to about 200 MPa. The thermoplastic poly(phenylene) polymer may have a flexural modulus of about 6 to about 6.5 GPa. The thermoplastic poly(phenylene) polymer may have a flexural strength of about 230 to about 250 MPa.

The reinforcement component may include: a carbon fiber, a glass fiber, an aramid fiber, a para-aramid fiber, a boron fiber, a basalt fiber, or any combination thereof.

In another aspect, the present disclosure provides a process for forming a composite material. The process includes: impregnating a reinforcement component with a solvent-dissolved thermoplastic poly(phenylene) polymer. The process may include removing at least a portion of the solvent from the impregnated reinforcement component, for example by evaporation. Using solvent-dissolved thermoplastic polymers to form composites has not been uniformly successful due to the difficulty of removing the solvents from the impregnated reinforcement components, and the difficulty in finding solvent/polymer combinations where the amorphous polymer is able to be dissolved in the solvent.

The impregnation may be achieved using a rotating drum, wet film application, or by fiber dipping which involves pulling fibers through a solution trough of polymer matrix. The solvent-dissolved thermoplastic poly(phenylene) polymer may be metered on the rotating drum using a doctor blade or a peristaltic pump.

The thermoplastic poly(phenylene) polymer may include para-phenylene units.

The solvent-dissolved thermoplastic poly(phenylene) polymer may be dissolved in any solvent that can solubilize the polymer and still be removed by evaporation. For example, the solvent may include a polar aprotic solvent. The polar aprotic solvent may be: N-methyl pyrrolidone (NMP), dimethylsulfoxide (DMSO), dimethyl formamide (DMF), dimethylacetamide (DMAC), or any combination thereof. Alternatively, a chlorinated solvent, such as methylene chloride, can be used, though such solvents may be less desirable due to toxicity issues, environmental issues, or both.

The solvent-dissolved thermoplastic poly(phenylene) polymer may be dissolved in a solvent mixture that also includes a second solvent compatible with the first solvent and the thermoplastic poly(phenylene) polymer. The second solvent can be any solvent that forms a homogeneous blend with the first solvent and that does not cause the polymer to phase separate from the first solvent. The second solvent may be, for example, acetone, toluene, xylene, or any combination thereof.

The solvent-dissolved thermoplastic poly(phenylene) polymer may be between 10 and 50% by weight of the polymer and solvent composition. For example, the solvent-dissolved thermoplastic poly(phenylene) polymer may be between 15 and 45% by weight of the polymer and solvent composition, or may be between 20 and 30% by weight of the polymer and solvent composition.

The process may also include molding the composite material at a temperature between about 150° C. and about 420° C. The process may also include molding the composite material at a pressure between about 5 psi to about 250 psi, or from about 35 kPa to about 1500 kPa.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures.

FIG. 1 is an illustration of a composite material.

FIG. 2 illustrates an example of one para-linked phenylene unit of a poly(phenylene) polymer.

FIG. 3 illustrates an example of one meta-linked phenylene unit of a poly(phenylene) polymer.

FIG. 4 is an illustration of a portion of a poly(phenylene) polymer having only para-linked phenylene units.

FIG. 5 is an illustration of a portion of a poly(phenylene) polymer having para-linked phenylene units and one meta-linked phenylene unit.

FIG. 6 is an unsubstituted meta-linked phenylene unit.

FIG. 7 is a schematic of an example of a fiber impregnation process according to the present disclosure.

FIG. 8 is a representation of ply layup.

FIG. 9 is a representation of a consolidated composite sheet with plural fiber angles.

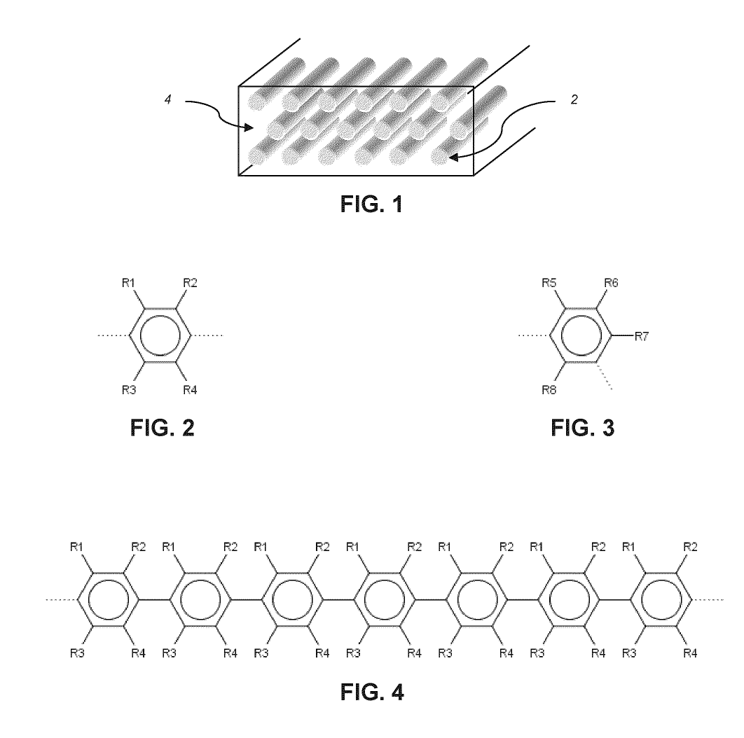

### DEFINITIONS

Throughout the present application, several terms are employed that are defined in the following paragraphs. These discussions of terms and phrases are intended to aid understanding of the present technology.

As used herein, the term “Composite Material” refers to a material system consisting of a mixture or combination of two or more micro- or macro-constituents that differ in form and chemical composition, and which are essentially insoluble in each other. In their most basic form, composite materials are a matrix (for example: polymer, ceramic, metal) with reinforcing agents (for example: fibers, whiskers, particulates).

As used herein, the terms “reinforcements” and “reinforcement component” refer to the principle load-bearing member of the composite material. Examples of reinforcement materials include carbon fiber (strong reinforcing fiber), boron fiber (superior to carbon fiber), aramid fiber (long chain polyamide with high tensile strength and light weight), para-aramid fiber (Kevlar® and Twaron®), basalt fiber (common extrusive volcanic rock used as alternative to metal reinforcements) and glass fiber (fiberglass) etc.

As used herein, the terms “matrix” and “matrix component” refer to the medium for binding and holding the reinforcements together, thereby forming a solid composite material, protecting the reinforcements from environmental degradation while providing finish, colour, texture, durability, or other functional properties.

As used herein, the term “polymer” refers to a molecule (macromolecule) composed of repeating structural units connected by covalent chemical bonds.

As used herein, the term “polymer matrix composite” refers to a polymer medium for binding and holding the reinforcements together, into a solid, protecting the reinforcement from environmental degradation while providing finish, colour, texture, durability and other functional properties.

As used herein, the terms “thermosetting polymer” and “thermoset polymer” refers to polymers that are heavily cross-linked to produce a strong three-dimensional network structure. These polymers are usually liquid or malleable prior to curing and are designed to be molded into a final form. Thermoset polymers have the property of undergoing a chemical reaction by the action of, for example, heat, a catalyst, or UV light to become an insoluble infusible substance. Once cross-linked, these thermosetting polymer they will decompose, rather than melt, at sufficiently elevated temperatures.

As used herein, the term “thermoplastic polymer” refers to polymers that are linear or branched in which chains are substantially not interconnected to one another. Thermoplastic polymers are held together by non-covalent bonds, such as Hydrogen bonds and/or Van Der Waals forces as well as physical entanglements. Heating thermoplastic polymers breaks these non-covalent bonds between polymer chains and the polymer can be molded into a new shape. These thermoplastic polymers become pliable or moldable above their glass temperature and return to solid state upon cooling.

As used herein, the term “tensile strength” is a measure of how much stress a polymer can endure before suffering permanent deformation. The tensile strength is the maximum amount of tensile stress that a material can withstand while being stretched or pulled before failing or breaking.

As used herein, the terms “tensile modulus” and “Young's Modulus” or “elastic modulus” is a measure of the elasticity of a polymer. The tensile modulus quantifies the elastic properties of linear objects which are either stretched or compressed and represents the ratio of the stress to the strain.

As used herein, the term “flexural modulus” is the ratio of stress to strain in flexural deformation, and is a measure of the tendency for a material to bend.

As used herein, the term “flexural strength” or “bend strength” or “fracture strength” is a measure of the ability of a material to resist deformation under load.

As used herein, the term “degradation temperature” means the temperature above which a polymer decomposes.

As used herein, the term “glass temperature” means the temperature range below which the amorphous polymer assumes a rigid glassy structure.

As used herein, the term “tows” refers to an untwisted bundle of continuous filaments. It may refer to man-made fibers, such as carbon fibers.

As used herein, the term “prepreg” refers to composite fibers where a matrix component, such as a polymer matrix of a resin, is impregnated in the fiber but the fiber has not been formed into its final composite structure.

### DETAILED DESCRIPTION

Generally, the present disclosure provides a method for producing a thermoplastic composite material. The method includes impregnating a fiber with a solvent-dissolved thermoplastic poly(phenylene) polymer. Particular examples of the method are discussed in greater detail below.

The present disclosure also provides a composite material that includes a thermoplastic poly(phenylene) polymer and a reinforcement component. The poly(phenylene) polymer may have a tensile modulus of about 5.5 to about 8 GPa, a tensile strength of about 150 to about 200 MPa, or both. The thermoplastic poly(phenylene) polymer may have a flexural modulus of about 6 to about 6.5 GPa, a flexural strength of about 230 to about 250 MPa, or both. The reinforcement component may have a high modulus, high strength, and/or highly oriented continuous reinforcing fibers. A tensile modulus of about 200 to about 700 GPa would be understood to be “high” for carbon fibers. A tensile modulus of about 70 to about 90 GPa would be understood to be “high” for glass fibers. A tensile strength of about 2 to about 7 GPa would be considered “high” for carbon fibers. A tensile strength of about 3.5 to about 4.5 GPa would be considered “high” for glass fibers.

The reinforcing fiber may be, for example: carbon fiber, glass fiber, aramid fiber, para-aramid fiber, boron fiber, basalt fiber, or any combination thereof. The thermoplastic poly(phenylene) polymer composites may be used in the manufacture of components for, for example: the automotive industry, the aerospace industry, the telecommunications industry, the electronics industry, or the sporting goods industry.

The thermoplastic poly(phenylene) polymer used to form a composite material according to the present disclosure may be a polymer that includes para-phenylene as monomeric units, or a polymer that includes both para-phenylene and meta-phenylene as monomeric units. The polymer may include monomeric para- and/or meta-phenylene units which are substituted with one or more polar non-acid functionalities. The polar non-acid functionalities may improve solubility of the thermoplastic poly(phenylene) polymer. The substituents in a multi-substituted phenylene unit may be the same or different. The substituent or substituents from one substituted phenylene unit may be the same or different from the substituent or substituents of another substituted phenylene unit.

A polymer that includes both para-phenylene and meta-phenylene as monomeric units may be formed using a ratio of para-phenylene to meta-phenylene from 500:1 to 1:4 mol/mol.

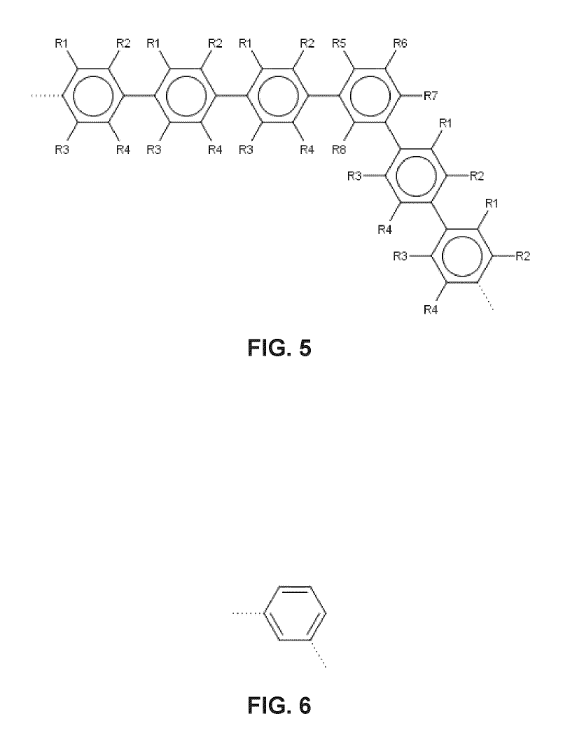

FIG. 2 illustrates an example of one para-linked phenylene unit of a poly(phenylene) polymer. The phenylene unit may be substituted at the R1, R2, R3 and/or R4 positions. FIG. 3 illustrates an example of one meta-linked phenylene unit of a poly(phenylene) polymer. The phenylene unit may be substituted at the R5, R6, R7 and/or R8 positions. FIG. 4 illustrates an example of a portion of a poly(phenylene) polymer having only para-linked phenylene units. FIG. 5 illustrates an example of a portion of a poly(phenylene) polymer having a mixture of para-linked phenylene units and a meta-linked phenylene unit. It is believed that meta-linked phenylene units introduce molecular flexibility in the polymer.

The substituents may be selected to change the chemical or mechanical properties of the polymer. For example, the substituents may be selected to improve the processing and functional properties of the resulting composite materials.

In particular examples, a poly(phenylene) polymer according to the present disclosure includes a para-linked phenylene unit which is mono substituted with a polar non-acid functional group, and an unsubstituted meta-linked phenylene unit. The exemplary polymer has the para- and meta-linked phenylene units in a ratio of about 5:1 mol/mol. FIG. 6 illustrates an unsubstituted meta-linked phenylene unit.

With regard to the method, the solvent used to dissolve the thermoplastic poly(phenylene) polymer may be a single solvent or a mixture of solvents. In particular examples, the solvent is a polar aprotic solvent such as, for example: N-methyl pyrrolidone (NMP), dimethylsulfoxide (DMSO), dimethyl formamide (DMF), or dimethylacetamide (DMAC). In other examples, the solvent is a mixture of a polar aprotic solvent and another solvent that is compatible with both the aprotic solvent and the thermoplastic poly(phenylene) polymer. The other solvent may be, for example: acetone, toluene, xylene, or any combination thereof.

Once dissolved in the solvent, the thermoplastic poly(phenylene) polymer may be between 10 and 50% by weight of the polymer/solvent composition. In particular examples, the thermoplastic poly(phenylene) polymer may be between 15 and 45%, or preferably between 20 and 30% by weight of the polymer/solvent composition.

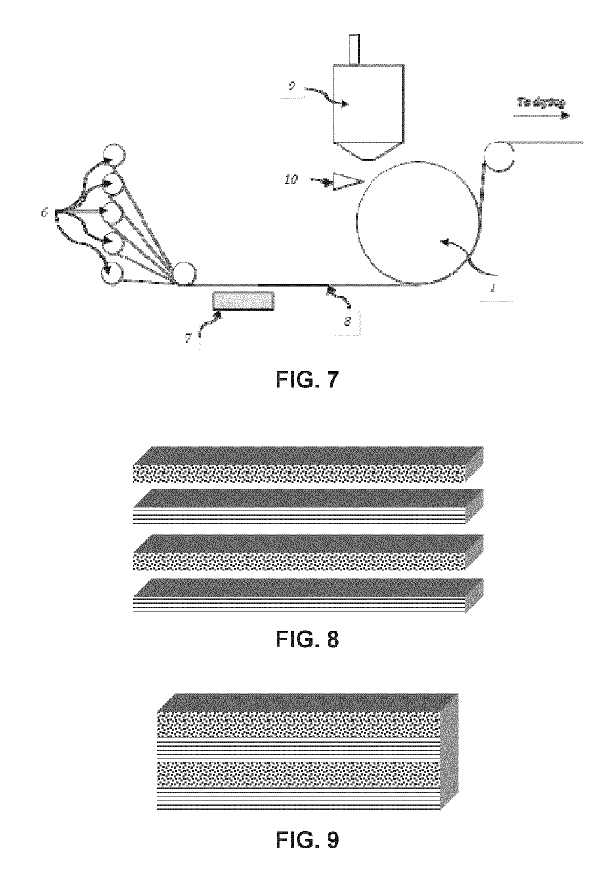

The fiber may be impregnated with the mixture of polymer and solvent using an impregnation rotating drum to control the matrix/fiber distribution. FIG. 7 is an illustration of an exemplary fiber impregnation process where the fibers are impregnated by the mixture of polymer and carrier using an impregnation rotating drum. In this exemplary process fiber tows (6) are first dried using an infrared heater (7) and then brought together side by side to form a fiber web (8). The polymer and solvent solution is then dispensed from a pressure pot (9) and metered by a doctor blade (10) to form a layer of controlled thickness on the impregnation rotating drum (11). The fiber web is brought in contact with the impregnation rotating drum (11), which is coated with the substantially uniform layer of the polymer solution and is then carried through a drying oven before being collected on a spool.

In the process illustrated in FIG. 7, the matrix-to-fiber volume ratio is controlled by the gap between the doctor blade (10) and the impregnation rotating drum (11). Additionally, the web width and the fiber spread are controlled by adjusting the tension on the fiber tows. The solvent may be partially or completely removed from the fiber-polymer solution mixture by evaporation, for example in drying ovens, to result in an impregnated unidirectional or multi-directional prepreg sheet or tape.

Such prepreg sheets of material may be stacked at varying angles with respect to the fiber direction to create preforms with desired mechanical properties, thickness and weight. FIG. 8 illustrates a ply layup. FIG. 9 illustrates a consolidated composite sheet with plural fiber angles.

The consolidation of the preforms may be completed, for example, by compression molding or stamping at temperatures between about 150° C. and about 420° C., pressures between about 35 kPa and about 1500 kPa.

Thermoplastic composites as described herein may be used in a variety of applications such as, for example, components for: automobiles, trucks, commercial airplanes, aerospace, hand held devices (such as cell phones), recreation or sports equipment (such as hockey sticks, golf clubs, bicycle frames, athletic shoes and helmets), structural components for machines, or electronics (such as laptops, tablets, and televisions).

### EXAMPLES

### Example 1

### Preparation of an Exemplary Poly(Phenylene) Matrix Solution

3000 grams of N-Methyl-2-pyrrolidone (NMP) were poured into a 5 liter round bottom reactor equipped with overhead stirrer, addition funnel, thermocouple and condenser. The reactor was placed in a heating mantle and the temperature was raised to 100° C. while stirring. 1000 grams of PrimoSpire® PR-250 self-reinforced poly(phenylene) from Solvay Plastics (an exemplary polypara(phenylene) polymer) was slowly added to the stirred NMP. After 3 hours, a 25% concentration by weight homogeneous and transparent solution was produced.

The PrimoSpire® PR-250 poly(phenylene) polymer has a tensile modulus of 5520 MPa, a tensile strength of 152 MPa, a flexural modulus of 6000 MPa, and a flexural strength of 234 MPa. It has a drying temperature of 149° C., a melt temperature of 343 to 349° C., and a mold temperature of 129 to 146° C.

3400 grams of NMP were poured in a 5 liter round bottom reactor equipped with overhead stirrer, addition funnel, thermocouple and condenser. The reactor was placed in a heating mantle and the temperature was raised to 100° C. while stirring. 600 grams of PrimoSpire® PR-250 self-reinforced poly(phenylene) from Solvay Plastics (an exemplary polypara(phenylene) polymer) was slowly added to the stirred NMP. After 3 hours, a 15% concentration by weight homogenous and transparent solution was produced.

### Example 2

### Preparation of an Exemplary Poly(Phenylene) Carbon Fiber Composite Material

The composite prepreg was prepared by depositing a film of a polymer solution (as prepared in Example 1) on the fiber tows, followed by drying the solvent in an oven. Specifically, the solution was dispensed from a reservoir and gravity-fed onto a rotating drum. The thickness of the polymer solution film was controlled by an adjustable doctor blade. The impregnated web was then pulled through an enclosed oven that was set at about 215° C. to evaporate the NMP solvent. The dried prepreg was collected with a take-up roller. The solvent vapor produced in the oven was forced through a solvent recovery cooling system. The out-going gas temperature of the solvent recovery system was 22° C. or less. The prepregs prepared had a nominal polymer content of about 40% by weight. The carbon fiber areal weight was about 66.7 g/m². Epoxy-sized carbon fiber (Grafil 34-700, Grafil Inc) was used.

### Example 3

### Testing of an Exemplary Poly(Phenylene) Carbon Fiber Composite Material

Dynamic Mechanical Analysis (DMA) analytical testing was done on the poly(phenylene) carbon fiber composite material. DMA is a technique used to study and characterize materials. It is most useful for studying the viscoelastic behavior of polymers. A sinusoidal strain is applied and the stress in the material is measured, allowing one to determine the elastic modulus (energy stored in the material) and the loss modulus (energy lost through heat). The temperature of the sample or the frequency of the stress are often varied, leading to variations in the moduli; this approach can be used to locate the glass transition temperature of the material, as well as to identify transitions corresponding to other molecular motions.

Poly(phenylene) carbon fiber composite samples measuring 4.9 mm in width, 2.0 mm in thickness and 60 mm in length were cut from consolidated unidirectional plates using a computer numerical control (cnc) mill. The fiber volume content of the samples was measured to be 52+/−1%. The samples were secured in the grips of a torsional hybrid rheometer/dma (Discovery Hybrid Rheometer—TA instruments, New Castle, Del.). The samples were prepared so that all the fiber reinforcements were parallel to the length of the sample. The temperature was controlled to 30° C.+/−0.1° C. by an environmental thermal chamber. The sample was deformed in torsion at a frequency of 1 hz and strain of 0.01% and the elastic and loss moduli was recorded. The elastic shear modulus was measured to be G′=6.2 GPa and the loss shear modulus was measured to be G″=136 MPa.

### Example 4

### Comparative Example of an Exemplary Poly(Phenylene) Carbon Fiber Composite Material

Three point bending is an International Standard test for fiber-reinforced thermoplastic composites (ISO 14125). The method determines the flexural properties of composites under three-point loading. The test specimen, supported as a beam, is deflected at a constant rate until the specimen fractures or until deformation reaches some pre-determined value. During this procedure, the force applied to the specimen and the deflection are measured. The method is used to investigate the flexural behavior of the test specimens and for determining flexural strength, flexural modulus and other aspects of flexural stress/strain relationship under the conditions defined. It applies to a freely supported beam, loaded in three-point flexure. The test geometry is chosen to limit shear deformation and to avoid an interlaminar shear failure.

In a paper “Thermoplastic Matrix Composites from Towpregs.” (Silva, J. et al., Advances in Composite Materials—Analysis of Natural and Man-made Materials. pp 307-324) a polyphenylene based prepreg is made using PrimoSpire® PR-120 with a powder impregnation method. PrimoSpire® PR-120 polymer has a tensile modulus of 8.3 GPa, a tensile strength of 207 MPa, a flexural modulus of 8.3 GPa, and a flexural strength of 310 MPa. This method results in a composite material with a flexural modulus of 30 GPa and flexural strength of 124 MPa for a 51% fiber volume unidirectional carbon fiber composite. Using the solvent method described in Example 2 to make an exemplary polyphenylene based prepreg using PrimoSpire® PR-250 resulted in a composite material with a flexural modulus of 117 GPa and a flexural strength of 1012 MPa.

In Table 1 the following formula was used to calculate a theoretical flexural modulus for the two methods of making composite materials. Theoretical=Rule of Mixture: (Composite longitudinal modulus)=(fiber volume content)*(Fiber longitudinal modulus)+(1−fiber volume content)*(Matrix modulus). As can be seen in Table 1, using this formula the theoretical flexural modulus was closer to the experimental value when using the solvent/solution method of the present disclosure in comparison to the powder impregnation method where the theoretical and experimental flexural modulus are quite disparate from each other.

TABLE 1

| | | Fiber | Theoretical | Experimental | Experimental/ |
|---|---|---|---|---|---|
| Method | Matrix | volume | Flex Modulus | Flex Modulus | Theoretical |
| Solvent/ | PrimoSpire ® | 52% | 124 Gpa | 117 Gpa | 94.4% |
| Solution | 250 Carbon fiber | | | | |
| impregnation | | | | | |
| Reference | PrimoSpire ® | 52% | 108 Gpa | 30 Gpa | 27.8% |
| Powder | 120 Carbon fiber | | | | |
| impregnation | | | | | |

In the preceding description, for purposes of explanation, numerous details are set forth in order to provide a thorough understanding of the examples. However, it will be apparent to one skilled in the art that these specific details are not required.

The above-described examples are intended to be exemplary only. Alterations, modifications and variations can be effected to the particular examples by those of skill in the art without departing from the scope, which is defined solely by the claims appended hereto.

What is claimed is:

1. A process for forming a composite material, the process comprising:
impregnating a reinforcement component with a solvent-dissolved thermoplastic poly(phenylene) polymer.

2. The process according to claim 1, wherein the reinforcement component is impregnated with the solvent-dissolved thermoplastic poly(phenylene) polymer using a rotating drum.

3. The process according to claim 2 wherein the solvent-dissolved thermoplastic poly(phenylene) polymer is metered on the rotating drug using a doctor blade or a peristaltic pump.

4. The process according to any one of claims 1-3 wherein the thermoplastic poly(phenylene) polymer comprises para-phenylene units.

5. The process according to any one of claims 1 to 4 wherein the solvent-dissolved thermoplastic poly(phenylene) polymer is dissolved in a solvent that will form a homogeneous mixture with the polymer.

6. The process according to claim 5 wherein the solvent is a polar aprotic solvent that is: N-methyl pyrrolidone (NMP), dimethylsulfoxide (DMSO), dimethyl formamide (DMF), dimethylacetamide (DMAC), or any combination thereof.

7. The process according to claim 5 or 6 wherein the solvent-dissolved thermoplastic poly(phenylene) polymer is dissolved in a solvent mixture further comprising a second solvent that forms a homogenous mixture with the first solvent and with the thermoplastic poly(phenylene) polymer, and that will not cause the polymer to separate from the first solvent.

8. The process according to claim 7 wherein the second solvent is acetone, toluene, xylene, or any combination thereof.

9. The process according to any one of claims 1 to 8 wherein the solvent-dissolved thermoplastic poly(phenylene) polymer is between 10 and 50% by weight of the polymer and solvent composition.

10. The process according to any one of claims 1 to 8 wherein the solvent-dissolved thermoplastic poly(phenylene) polymer is between 15 and 45% by weight of the polymer and solvent composition.

11. The process according to any one of claims 1 to 8 wherein the solvent-dissolved thermoplastic poly(phenylene) polymer is between 20 and 30% by weight of the polymer and solvent composition.

12. The process according to any one of claims 1 to 11, further comprising molding the composite material at a temperature between about 150° C. and about 420° C.

13. The process according to any one of claims 1 to 12, further comprising molding the composite material at a pressure between about 35 kPa to about 1500 kPa.

14. A composite material comprising:
a reinforcement component; and
a thermoplastic poly(phenylene) polymer comprising para-phenylene units.

15. The composite material according to claim 14, wherein at least a portion of the para-phenylene units are substituted with a polar non-acid functional group.

16. The composite material according to claim 14 or 15, wherein the thermoplastic poly(phenylene) polymer further comprises meta-phenylene units.

17. The composite material according to claim 16 wherein the para-phenylene and meta-phenylene units are present in a ratio of from 500:1 to 1:4 mol/mol.

18. The composite material according to claim 16 wherein the para-phenylene and meta-phenylene units are present in a ratio of about 5:1 mol/mol.

19. The composite material according to any one of claims 14 to 18, wherein the thermoplastic poly(phenylene) polymer has a tensile modulus of about 5.5 to about 8 GPa.

20. The composite material according to any one of claims 14 to 19, wherein the thermoplastic poly(phenylene) polymer has a tensile strength of about 150 to about 200 MPa.

21. The composite material according to any one of claims 14 to 20, wherein the thermoplastic poly(phenylene) polymer has a flexural modulus of about 6 to about 6.5 GPa.

22. The composite material according to any one of claims 14 to 21 wherein the thermoplastic poly(phenylene) polymer has a flexural strength of about 230 to about 250 MPa.

23. The composite material according to any one of claims 14 to 21, wherein the reinforcement component comprises: a carbon fiber, a glass fiber, an aramid fiber, a para-aramid fiber, a boron fiber, a basalt fiber, or any combination thereof.

24. A composite material made according to the process according to any one of claims 1-13.
